(19) United States
(12) Patent Application Publication
(10) Pub. No.: US 2026/0323589 A1
(43) Pub. Date: Oct. 15, 2026

(54) MOVEMENT ASSESSMENT DEVICE

(71) Applicant: NTT DOCOMO, INC., Tokyo (JP)

(72) Inventor: Shin ISHIGURO, Tokyo (JP)

(73) Assignee: NTT DOCOMO, INC., Tokyo (JP)

(21) Appl. No.: 19/144,999

(22) PCT Filed: Nov. 17, 2023
(86) PCT No.: PCT/JP2023/041502

§ 371 Date: Jul. 1, 2025

(30) Foreign Application Priority Data
Feb. 9, 2023 (JP) 2023-018543

(51) Int. Cl. H04W 64/00; H04B 17/309; H04B 17/318; H04W 4/40

(52) U.S. Cl. CPC H04W 64/006; H04B 17/328; H04B 17/346; H04W 4/40

(57) ABSTRACT

To make a determination as to whether or not two terminals performing mobile communication are moving together. A movement determination device 1 includes a determination unit 14 configured to make a determination, based on comparison of communication information relating to communication between each of two terminals 3a and 3b performing mobile communication and a base station 2 at predetermined time, as to whether or not the two terminals 3a and 3b are moving together at the predetermined time. The terminal 3a between the two terminals 3a and 3b may be carried by a user 4a, the terminal 3b may be installed in a bus 5a, and the determination unit 14 may make a determination as to whether or not the user 4a is moving on the bus 5a at predetermined time. The communication information may be information relating to quality of communication with the base station 2.

### TECHNICAL FIELD

An aspect of the present disclosure relates to a movement determination device that determines whether or not two terminals performing mobile communication are moving together.

### BACKGROUND ART

Patent Literature 1 discloses a moving body location detection terminal device that acquires, via a wireless base station, moving body information obtained by receiving radio waves transmitted from a moving body radio device that is small enough to be attached to the moving body, and detects a location of the moving body radio device.

### CITATION LIST

### Patent Literature

Patent Literature 1: Japanese Unexamined Patent Publication No. 2008-124995

### SUMMARY OF INVENTION

### Technical Problem

However, the above-described moving body location detection device can detect only a location of one moving body radio device. Therefore, it is difficult to detect, for example, whether or not two moving body radio devices are moving together. Here, it is desired to determine whether or not two terminals performing mobile communication are moving together.

### Solution to Problem

A movement determination device according to an aspect of the present disclosure includes a determination unit configured to make a determination, based on comparison of communication information relating to communication between each of two terminals performing mobile communication and a base station at predetermined time, as to whether or not the two terminals are moving together at the predetermined time.

In this aspect, determination is made as to whether or not two terminals performing mobile communication are moving together at predetermined time based on comparison of communication information of each of the terminals at the predetermined time. That is, it is possible to determine whether or not two terminals performing mobile communication are moving together.

### Advantageous Effects of Invention

According to the aspect of the present disclosure, it is possible to determine whether or not two terminals performing mobile communication are moving together.

### BRIEF DESCRIPTION OF DRAWINGS

FIG. 1 A view illustrating an example of a system configuration of a movement determination system including a movement determination device according to an embodiment.

FIG. 2 A sequence diagram illustrating an example of a process executed by the movement determination system.

FIG. 3 A view illustrating an example of a functional configuration of the movement determination device according to the embodiment.

FIG. 4 A view illustrating a table example of base station communication information table.

FIG. 5 A view illustrating a table example of device location information table.

FIG. 6 A flowchart illustrating an example of a registration process executed by the movement determination device according to the embodiment.

FIG. 7 A view illustrating a table example of a bus stop arrival/departure information table.

FIG. 8 A view illustrating a table example a correspondence information table of a device ID and a bus ID.

FIG. 9 A view illustrating a table example of a bust stop latitude/longitude information table.

FIG. 10 A view illustrating a table example of a series data table of communication records of a terminal.

FIG. 11 A flowchart illustrating an example of an extraction process executed by the movement determination device according to the embodiment.

FIG. 12 A view illustrating a venn diagram example of a logical product of base station sets.

FIG. 13 A view illustrating a venn diagram example of logical OR of the base station sets.

FIG. 14 A view illustrating a table example of a transportation means determination result table.

FIG. 15 A flowchart illustrating an example of a determination process executed by the movement determination device according to the embodiment.

FIG. 16 A view illustrating an example of a hardware configuration of a computer that is used as the movement determination device according to the embodiment.

### DESCRIPTION OF EMBODIMENTS

Hereinafter, an embodiment of the present disclosure will be described in detail with reference to the accompanying drawings. Note that, in description of the drawings, the same reference numeral will be given to the same element, and redundant description thereof will be omitted. In addition, the embodiment in the present disclosure in the following description is a specific example of the invention, and it is assumed that the invention is not limited to the embodiment unless otherwise specified to limit the invention.

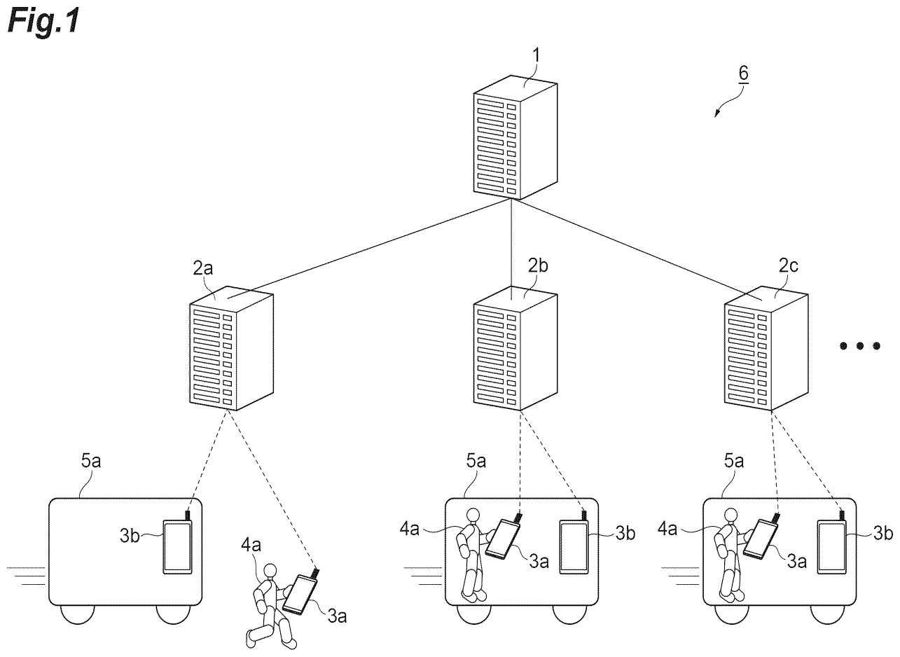

FIG. 1 is a view illustrating an example of a system configuration of a movement determination system 6 including a movement determination device 1 according to the embodiment. As shown in FIG. 1, the movement determination system 6 includes the movement determination device 1, one or more base stations 2 (a base station 2a, a base station 2b, a base station 2c, . . . , and the like are collectively referred to as “base stations 2”), two or more terminals 3 (a terminal 3a, a terminal 3b, a terminal 3c, . . . , and the like are collectively referred to as “terminal 3”), one or more users 4 (a user 4a, a user 4b, a user 4c, . . . , and the like are collectively referred to as “user 4”), and one or more buses 5 (a bus 5a, a bus 5b, a bus 5c, . . . , and the like are collectively referred to as “bus 5”).

The movement determination device 1 and each of the base stations 2 are communicatively connected to each other via a wired network or the like, and can transmit and receive information to and from each other. Each of the base stations 2 and each of the terminals 3 are communicatively connected to each other via wireless network, and can transmit and receive information to and from each other.

The movement determination device 1 is a computer device that determines whether or not two terminals are moving together at predetermined time (whether or not the user 4a carrying the terminal 3a is moving on the bus 5a in which the terminal 3b is installed) based on comparison of communication information (described later) relating to communication between each of the two terminals performing mobile communication (in the embodiment, terminals 3a and 3b are mainly set as a target) and the base station 2 at the predetermined time. The predetermined time may be arbitrary time (period), a target time (period), time (period) designated by a manager of the movement determination device 1 or the like, a period from arbitrary first time to arbitrary second time (different from the first time), and the like. Details of the movement determination device 1 will be described later.

The base station 2 is a constituent element of a typical mobile communication network. The base station 2 performs wireless communication in the mobile communication with the terminal 3, and relays communication from the terminal 3 or communication to the terminal 3. Each of the base stations 2 constitutes a cell that is a range at which radio waves arrive, and performs communication with the terminal 3 in the cell. The base station 2 has functions which are provided in a typical base station.

The terminal 3 is a constituent element of a typical mobile communication network. Examples of the terminal 3 include a smartphone and the like. The terminal 3 performs mobile communication via the base station 2. The terminal 3 has functions provided in a typical user equipment (UE). The terminal 3 may be carried by the user 4. The terminal 3 may be installed in the bus 5. In the embodiment, as shown in FIG. 1, description has been made on the assumption that between two terminals 3 including the terminal 3a and the terminal 3b, one terminal 3a is carried by the user 4a, and the other terminal 3b is installed in the bus 5a, but there is no limitation thereto.

The user 4 is a person who uses the mobile communication network. The user 4 may carry the terminal 3. The user 4 may move by walking, or on the bus 5.

The bus 5 is a general vehicle capable of moving by carrying the user 4. The bus 5 may be equipped with the terminal 3 (fixed inside the bus 5, carried by a driver of the bus 5). In the embodiment, the bus 5 may be replaced with an arbitrary vehicle such as a car, a taxi, a truck, a bicycle, a train, an airplane, or a ship.

FIG. 1 shows three scenes (by one drawing) in which the user 4a who carries the terminal 3a, and the bus 5a equipped with the terminal 3b are moving. In a first scene, the user 4a is waiting at a bus stop, and the bus 5a is travelling toward the bus stop (without passengers). In the first scene, the terminal 3a and the terminal 3b are located within a cell of the base station 2a. In a second scene, the user 4a is moving on the bus 5a (at the bus stop). In the second scene, the terminal 3a and the terminal 3b are located within a cell of the base station 2b. In a third scene, as in the second scene, the user 4a is moving on the bus 5a, but movement is progressed, and thus the terminal 3a and the terminal 3b are located within a cell of the base station 2c (different from the base station 2b). That is, when the user 4a moves on the bus 5a, the base station 2 constituting a cell in which the terminal 3a and the terminal 3b are located is changed in accordance with movement.

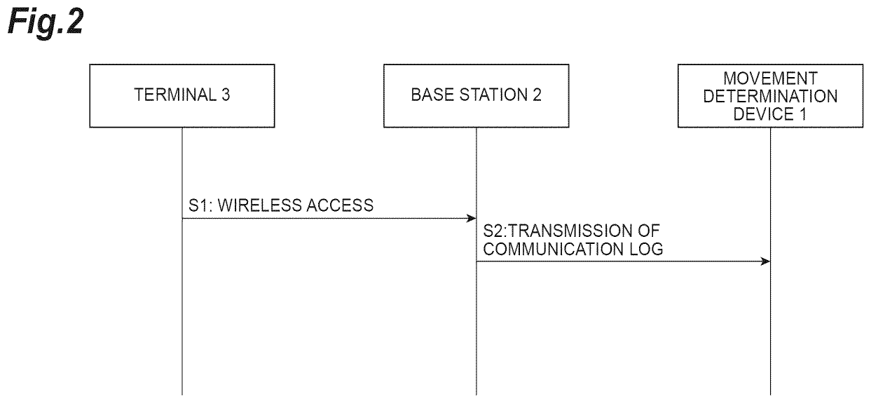

FIG. 2 is a sequence diagram illustrating an example of a process executed by the movement determination system 6. First, the terminal 3 wirelessly access the base station 2 (step S1). The wireless access is, for example, transmission of a location registration signal. Next, the base station 2 transmits a communication log to the movement determination device 1 (step S2). The communication log is a log (wireless access log) based on the wireless access in S1.

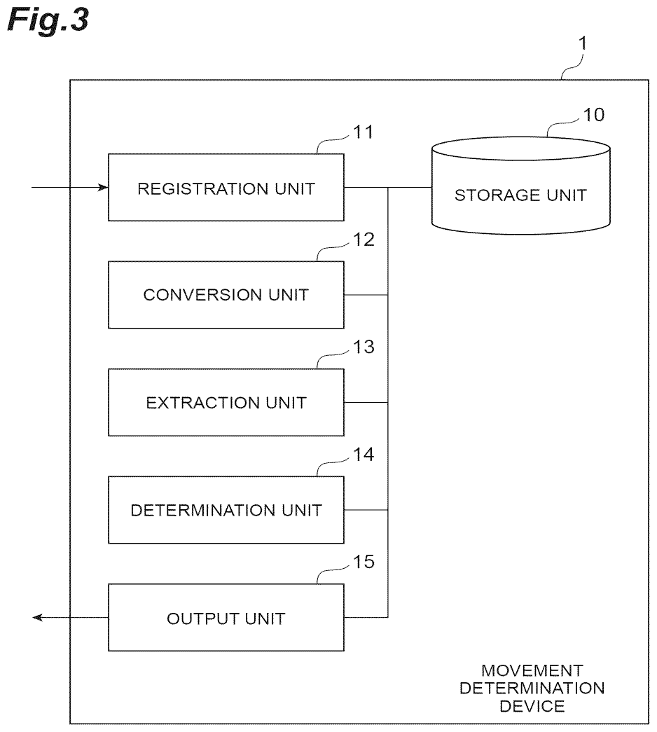

FIG. 3 is a view showing an example of a functional configuration of the movement determination device 1 according to the embodiment. As shown in FIG. 3, the movement determination device 1 includes a storage unit 10, a registration unit 11, a conversion unit 12, an extraction unit 13, a determination unit 14 (determination unit), and an output unit 15.

It is assumed that each functional block of the movement determination device 1 functions in the movement determination device 1, but there is no limitation thereto. For example, some of the functional blocks of the movement determination device 1 may function in a computer device that is different from the movement determination device 1 and is connected to the movement determination device 1 via a network while appropriately transmitting and receiving information to and from the movement determination device 1. In addition, some of the functional blocks of the movement determination device 1 may be omitted, a plurality of functional blocks may be integrated into one functional block, or one functional block may be decomposed into a plurality of functional blocks.

For example, the storage unit 10 may be separated independently as a database system, the registration unit 11 and the conversion unit 12 may be separated independently as a location registration system, and the extraction unit 13, the determination unit 14, and the output unit 15 may be separated independently as a transportation means determination system. In addition, the database system, the location registration system, and the transportation means determination system may be treated as a server group.

Hereinafter, respective functions of the movement determination device 1 shown in FIG. 3 will be described.

The storage unit 10 stores arbitrary information used in calculation in the movement determination device 1, calculation results in the movement determination device 1, and the like. The information stored in the storage unit 10 may be appropriately referred to by the respective functions of the movement determination device 1.

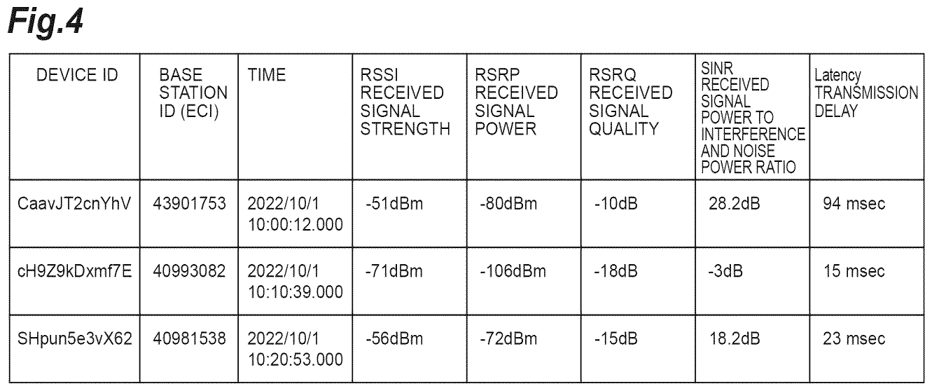

The registration unit 11 registers the communication logs of the terminal 3a and the terminal 3b which are received from the base station 2 in a base station communication information table stored in the storage unit 10. FIG. 4 is a view showing a table example of the base station communication information table. In the base station communication information table shown in FIG. 4, a device ID that is identification information of the terminal 3, a base station ID (ECI; E-UTRAN Cell ID) that is identification information of the base station 2 that is wirelessly accessed by the terminal 3, time (date and time) at which the wireless access is made, received signal strength indicator (RSSI) (received signal strength) (unit: dBm) associated with the wireless access, reference signal received power (RSRP) (received signal power) (unit: dBm) associated with the wireless access, reference signal received quality (RSRQ) (received signal quality) (unit: dB) associated with the wireless access, signal to interference plus noise ratio (SINR) (received signal power to interference and noise power ratio) (unit: dB) associated with the wireless access, and Latency (transmission delay) (unit: msec) associated with the wireless access are associated with each other. Note that, RSSI, RSRP, RSRQ, SINR, and Latency are information relating to a quality of the wireless access communication.

The conversion unit 12 converts the communication logs of the terminal 3a and the terminal 3b, which are received from the base station 2, into latitude and longitude, and registers the latitude and the longitude in a device location information table stored in the storage unit 10. The conversion unit 12 performs a process of estimating the latitude and the longitude with respect to information of communication generated during location registration. The conversion (estimation) into latitude and longitude uses an existing technology. For example, an assisted-global navigation satellite system (A-GNSS) that is a method of performing correction by comparing global positioning system (GPS) information measured by a user-side terminal (UE) and GPS satellite information acquired on a network side may be used, observed time difference of arrival (OTDOA) that is a method of calculating a distance from arrival time of a signal received from a plurality of base stations (eNB), and obtaining an intersection point may be used, or enhanced-cell ID (ECID) that is a method of measuring a location by using an ID of a base station to be accessed, the transmission delay measured by a difference in communication transmission and reception timing, and an arrival angle of a signal may be used.

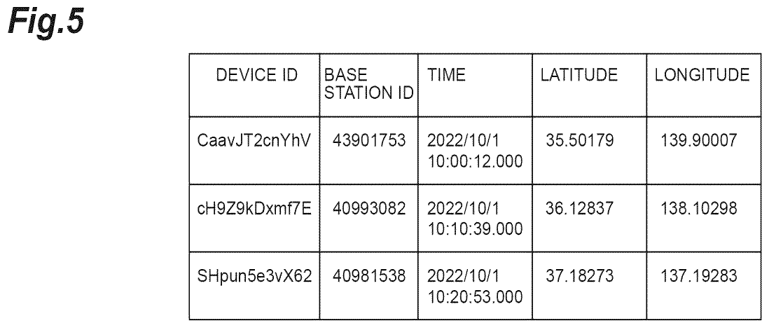

FIG. 5 is a view illustrating a table example of the device location information table. In the device location information table shown in FIG. 5, the device ID that is identification information of the terminal 3, the base station ID that is identification information of the base station 2 that is wirelessly accessed by the terminal 3, time (date and time) at which the wireless access is made, (estimated) latitude of the terminal 3 when the terminal 3 makes the wireless access, and (estimated) longitude of the terminal 3 when the terminal 3 makes the wireless access are associated with each other.

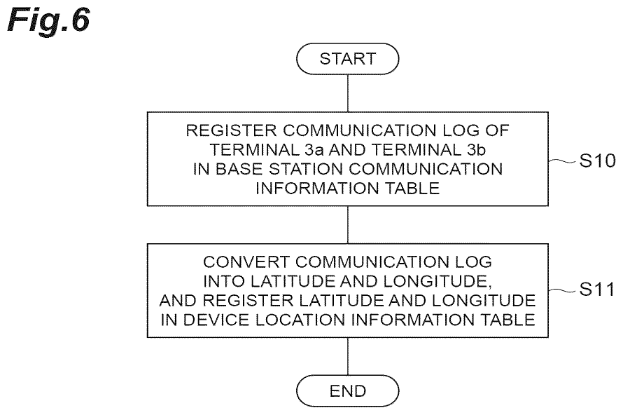

FIG. 6 is a flowchart illustrating an example of a registration process executed by the movement determination device 1. First, the registration unit 11 registers the communication logs of the terminal 3a and the terminal 3b in the base station communication information table (step S10). Next, the conversion unit 12 converts the communication logs into latitude and longitude, and registers the latitude and the longitude in the device location information table (step S11).

The extraction unit 13 extracts series data of communication records relating to communication between each of the terminal 3a and the terminal 3b and the base station 2 at predetermined time.

First, description will be given of extraction of series data of the terminal 3b installed in the bus 5a. The extraction unit 13 compares a bus stop arrival/departure information table and time of the base station communication information table of the bus 5a and extracts series data of communication records at an arbitrary section (or a section and time of interest). The extraction unit 13 may refer to at least one of a correspondence information table between the device ID and the bus ID, and a latitude/longitude information table of a bus stop during extraction.

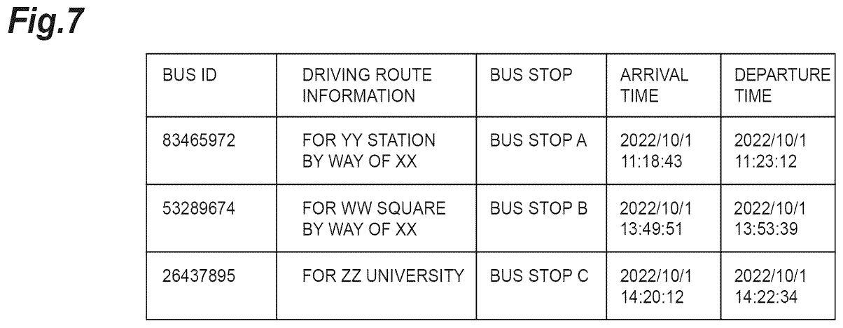

FIG. 7 is a view showing a table example of the bus stop arrival/departure information table. In the bus stop arrival/departure information table shown in FIG. 7, a bus ID that is identification information of the bus 5, driving route information relating to a driving route of the bus 5, a bust stop (identification information thereof) at which the bus 5 stops, arrival time that is time (date and time) at which the bus 5 arrives at the bus stop, and departure time that is time (date and time) at which the bus 5 departures the bus stop are associated with each other. Note that, the process described in the embodiment can be executed by information on only one of the arrival time and the departure time. Both the arrival time and the departure time may be recorded in consideration of a case where the bus 5 stays at the bus stop for a long time.

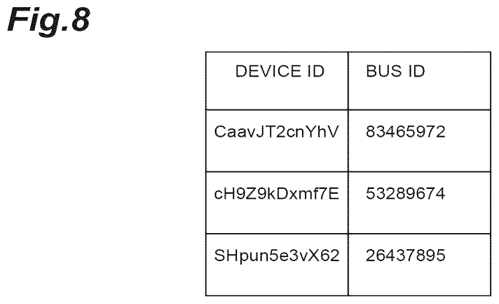

FIG. 8 is a view illustrating a table example of a correspondence information table of the device ID and the bus ID. In the correspondence information table of the device ID and the bus ID shown in FIG. 8, the device ID that is identification information of the terminal 3 installed in the bus 5, and the bus ID that is identification information of the bus 5 are associated with each other.

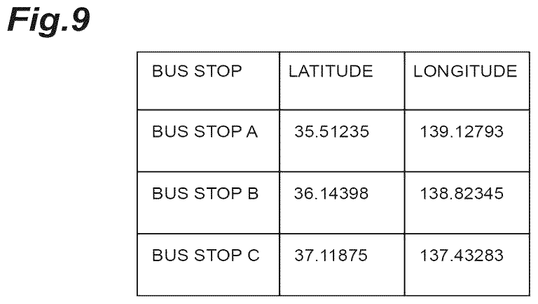

FIG. 9 is a view showing a table example of a latitude/longitude information table of a bus stop. In the latitude/longitude information table of the bus stop shown in FIG. 9, the bus stop (identification information thereof), latitude at which the bus stop is located, and longitude at which the bus stop is located are associated with each other.

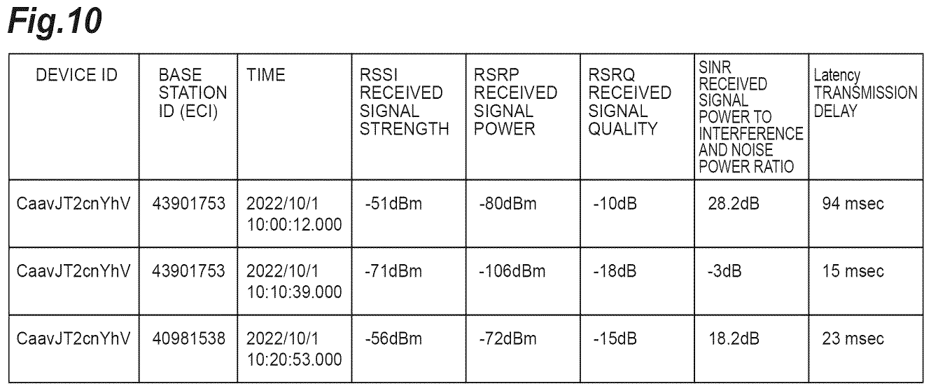

FIG. 10 is a view showing a table example of series data table of communication records of a terminal. In the series data table of communication records of a terminal shown in FIG. 10, a device ID that is identification information of the terminal 3, a base station ID (ECI) that is identification information of the base station 2 that is wirelessly accessed by the terminal 3, time (date and time) when the wireless access is made, RSSI associated with the wireless access, RSRP associated with the wireless access, RSRQ associated with the wireless access, SINR associated with the wireless access, and Latency associated with the wireless access are associated with each other. The series data table of the communication records of the terminal may be series data searched with respect to the base station communication information table by using a specific device ID, and from predetermined start time to predetermined end time as conditions.

Next, description will be given of extraction of series data of the terminal 3a carried by the user 4a. The extraction unit 13 extracts the device ID (a plurality of the device IDs are possible) of the terminal 3a carried by the user 4a who moves through same section at the same time from the device location information table based on latitude, longitude, and time of departure and arrival points from the bus stop arrival/departure information table (this is also a process of determining a start point and an end point for applying DTW (described later) to trajectory data to be compared). The extraction unit 13 may also refer to at least one of the device ID, the correspondence information table of the bus ID, and the latitude/longitude information table of the bus stop during extraction.

The extraction unit 13 may extract a device ID in which location information that falls within an arbitrary distance around the bus stop and within a threshold value in a deviation before and after arbitrary time is recorded. This is to provide a buffer for time and distance since there is a possibility that data may not be recorded near the bus stop due to a recording period of the location registration signal. In addition, in a case where the number of samples during extraction is insufficient and it is not determined that the bus is used, the extraction unit 13 may add a method of applying a process of increasing the number of point groups of a movement trajectory by linear interpolation, spline interpolation, or the like, a method of applying a process of estimating a movement route by performing map matching and routing and detecting whether or not a road near the bus stop is used for travelling.

The extraction unit 13 may extract a plurality of device IDs as described above as “a plurality of device IDs are possible”. In this case, the subsequent processes are repeatedly executed with respect to all extracted device IDs. Hereinafter, description of the repetitive execution will be appropriately omitted.

Next, the extraction unit 13 extracts series data of communication records from a departure time to an arrival time of the extracted device ID of the terminal 3a carried by the user 4a from the base station communication information table. The extracted series data of the communication records is similar to that shown in FIG. 10.

The extraction unit 13 may output the extracted series data of the terminal 3a installed in the bus 5a, and the extracted series data of the terminal 3a carried by the user 4a to the determination unit 14 and the output unit 15, or may store the series data in the storage unit 10.

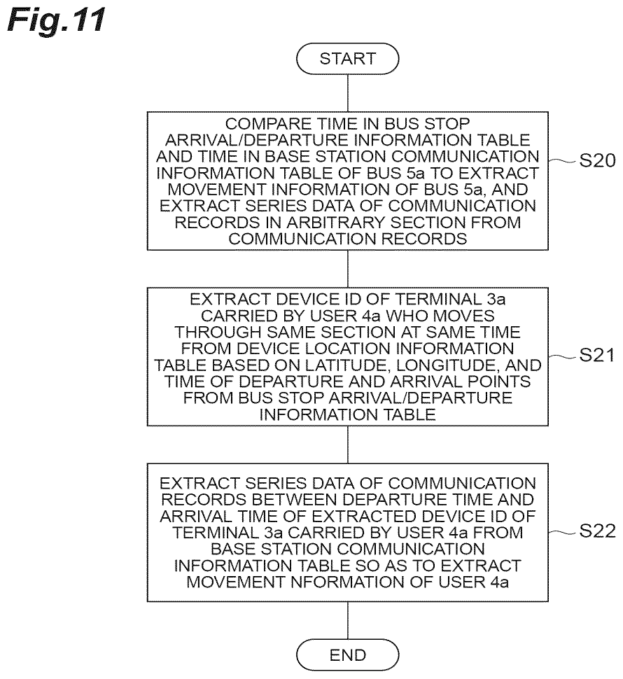

FIG. 11 is a flowchart showing an example of the extraction process executed by the movement determination device 1. First, the extraction unit 13 compares time in the bus stop arrival/departure information table and time in the base station communication information table of the bus 5a to extract movement information of the bus 5a, and extracts series data of communication records in an arbitrary section from the communication records (step S20). Next, the extraction unit 13 extracts the device ID of the terminal 3a carried by the user 4a who moves through the same section at the same time from the device location information table based on latitude, longitude, and time of departure and arrival points from the bus stop arrival/departure information table (step S21). Next, the extraction unit 13 extracts series data of communication records between a departure time and an arrival time of the device ID, which is extracted in S21, of the terminal 3a carried by the user 4a from the base station communication information table so as to extract movement information of the user 4a (step S22).

Based on comparison of communication information relating to communication between each of two terminals 3 (the terminal 3a and the terminal 3b) that perform mobile communication and the base station 2 at predetermined time, the determination unit 14 determines whether or not the two terminals 3 are moving together at the predetermined time. The determination unit 14 may determine whether or not the user 4 (the user 4a who carries the terminal 3a) moves on the bus 5 (the bus 5a equipped with the terminal 3b) at predetermined time.

The communication information may be information relating to quality of communication with the base station 2. The communication information may be information relating to at least one of RSSI, RSRP, RSRQ, SINR, and a transmission delay. The communication information may be time series data.

The determination unit 14 may acquire communication information of each of the two terminals 3 at predetermined time, and may make the determination (described above) based on comparison of acquired communication information. The determination unit 14 may output the determination result (information indicating whether or not the two terminals 3 are moving together at the predetermined time, information indicating whether or not the user 4 is moving on the bus 5, or the like) to the output unit 15, or may store the determination result in the storage unit 10.

The determination unit 14 may calculate a similarity of communication information of each of the two terminals 3 at predetermined time, and may make the determination (described above) based on the calculated similarity. The determination unit 14 may calculate a similarity of a set of time series data elements relating to communication with the same base station 2 among a plurality of pieces of communication information of each of the two terminals 3 at predetermined time, and may make the determination (described above) based on the calculated similarity of each set. The determination unit 14 may make the determination (described above) also based on a penalty based on time series data element leaked out from the set (time series data element that cannot be included in a set of time series data elements relating to communication with the same base station 2). The determination unit 14 may calculate the similarity (described above) by dynamic time warping (DTW).

Hereinafter, details of determination by the determination unit 14 will be described.

The determination unit 14 executes DTW based on information relating to communication quality (RSSI, RSRP, RSRQ, SINR, Latency, and recording time) or estimated latitude and longitude information (Lat, Lon). Here, the RSSI, RSRP, RSRQ, SINR, and Latency are used as representative communication quality. However, it is also possible to add and use another available information relating to communication quality. Conversely, in a case where there is some type of data that cannot be acquired, it is possible to perform calculation even though the data is excluded from usage data. The DTW is a method of calculating an error of all sets of two pieces of time series data, and obtaining a combination that minimizes the sum. In the embodiment, a value of the sum of the error calculated as a result of DTW is treated as the similarity.

Description will be given of symbols used in the following description. S_{User} is set as series data of communication records of the terminal 3a carried by the user 4a. S_{Bus} is set as series data of communication records of the terminal 3b installed in the bus 5a. x_{y}={x^{RSSI}, x^{RSRP}, x^{RSRQ}, x^{SINR}, x^{Latency}} is set as one record of communication records at a base station y. S shown in the following formula is an expression of series data.

$$S = [ {x}_{1}^{{y}_{1}} , {x}_{2}^{{y}_{1}} , … , {x}_{{m}_{1}}^{{y}_{1}} , {x}_{1}^{{y}_{2}} , {x}_{2}^{{y}_{2}} , … , {x}_{{m}_{2}}^{{y}_{2}} , … , {x}_{1}^{{y}_{M}} , {x}_{2}^{{y}_{M}} , … , {x}_{{m}_{M}}^{{y}_{M}} ] \qquad [ Formula 1 ]$$

The base station 2 is expressed as y₁, y₂, . . . , y_{M} on the assumption that there are M base stations 2. Here, M may be the number of all base stations 2 owned by an administrator (management organization) of a mobile communication network, or may be the union of sets of the base stations 2 in which wireless access of the terminal 3a and the terminal 3b is recorded. For each base station yᵢ, mi pieces of variable length series data are recorded. There may be a base station 2 with zero data. In this case, the series data x of the base station 2 becomes an empty set. When focusing on the base station yᵢ, x₁, x₂, . . . ,

$${x}_{{m}_{i}} \qquad [ Formula 2 ]$$

represents mi pieces of series data. Data xⱼ represents,

$$\{ {x}^{{RSSI}_{j}} , {x}^{{RSRP}_{j}} , {x}^{{RSRQ}_{j}} , {x}^{{SINR}_{j}} , {x}^{{Latency}_{j}} \} \qquad [ Formula 3 ]$$

All records of the series data are accompanied by time information t that is time at which communication information is recorded. For example,

$${x}_{j}^{{y}_{i}} \qquad [ Formula 4 ]$$

represents j^{th} record in the base station yᵢ.

Time in

$${x}_{j}^{{y}_{i}} \qquad [ Formula 5 ]$$

is expressed as

$${t}_{j}^{{y}_{i}} \qquad [ Formula 6 ]$$

The DTW generally creates a distance between two points all records for two pieces of series data, and extracts a pair with the shortest distance for each record. The sum of these distances is the similarity calculated by the DTW. In a specific example shown in the embodiment, since the data is not one-dimensional, a difference (=distance) between the same elements is calculated, and the sum of distances of all elements is calculated, and then multi-dimensional DTW is solved so that the sum of the distances becomes the shortest.

The distance between two points used in the DTW is calculated as a Euclidean distance in the embodiment, but other distance functions may be used. For example, a distance between record x₀ and x₁ is calculated by

$$distance ( {x}_{0} , {x}_{1} ) = \sqrt{{( {x}_{1} - {x}_{0} )}^{2} + {( {t}_{1} - {t}_{0} )}^{2}} \qquad [ Formula 7 ]$$

Here t corresponds to time at which communication information is recorded. Distance calculation of series data is executed by using the time t of each record.

An example of the distance calculation of one record is shown by the following formula.

$$distance ( {x}_{0}^{y} , {x}_{1}^{y} ) = {λ}_{RSSI} \cdot distance ( {x}_{0}^{RSSI} , {x}_{1}^{RSSI} ) + {λ}_{RSRP} \cdot distance ( {x}_{0}^{RSRP} , {x}_{1}^{RSRP} ) + {λ}_{RSRQ} \cdot distance ( {x}_{0}^{RSRQ} , {x}_{1}^{RSRQ} ) + {λ}_{SINR} \cdot distance ( {x}_{0}^{SINR} , {x}_{1}^{SINR} ) + {λ}_{Latency} \cdot distance ( {x}_{0}^{Latency} , {x}_{1}^{Latency} ) = {λ}_{RSSI} \sqrt{{( {x}_{0}^{RSSI} - {x}_{1}^{RSSI} )}^{2} + {( {t}_{1} - {t}_{0} )}^{2}} + {λ}_{RSRP} \sqrt{{( {x}_{0}^{RSRP} - {x}_{1}^{RSRP} )}^{2} + {( {t}_{1} - {t}_{0} )}^{2}} + {λ}_{RSRQ} \sqrt{{( {x}_{0}^{RSRQ} - {x}_{1}^{RSRQ} )}^{2} + {( {t}_{1} - {t}_{0} )}^{2}} + {λ}_{SINR} \sqrt{{( {x}_{0}^{SINR} - {x}_{1}^{SINR} )}^{2} + {( {t}_{1} - {t}_{0} )}^{2}} + {λ}_{Latency} \sqrt{{( {x}_{0}^{Latency} - {x}_{1}^{Latency} )}^{2} + {( {t}_{1} - {t}_{0} )}^{2}} \qquad [ Formula 8 ]$$

Here, λ a weight coefficient value that determines which parameter is to be emphasized. Ground truth data of bus usage determination (determination as to whether or not the user 4 is moving on the bus 5) may be prepared, and may be set to perform parameter searching so that determination accuracy is maximized.

The determination unit 14 creates a pair of records having a matching base station ID in two pieces of series data, and performs distance calculation for the created pair. For example, series data of each of S_{User} and S_{Bus} is expressed by the following formulae.

$${S}_{User} = [ {x}_{1}^{{y}_{1}} , {x}_{2}^{{y}_{1}} , … , {x}_{{m}_{1}}^{{y}_{1}} , {x}_{1}^{{y}_{2}} , {x}_{2}^{{y}_{2}} , … , {x}_{{m}_{2}}^{{y}_{2}} , … , {x}_{1}^{{y}_{M}} , {x}_{2}^{{y}_{M}} , … , {x}_{{m}_{M}}^{{y}_{M}} ] \qquad [ Formula 9 ]$$

$${S}_{Bus} = [ {x}_{1}^{{y}_{1}} , {x}_{2}^{{y}_{1}} , … , {x}_{{{m}^{′}}_{1}}^{{y}_{1}} , {x}_{1}^{{y}_{2}} , {x}_{2}^{{y}_{2}} , … , {x}_{{{m}^{′}}_{2}}^{{y}_{2}} , … , {x}_{1}^{{y}_{M}} , {x}_{2}^{{y}_{M}} , … , {x}_{{{m}^{′}}_{M}}^{{y}_{M}} ] \qquad [ Formula 10 ]$$

In this case, for example, the determination unit 14 creates a pair (first pair) of S_{User}'s

$${x}_{1}^{{y}_{1}} , {x}_{2}^{{y}_{1}} , … , {x}_{{m}_{1}}^{{y}_{1}} and {S}_{Bus} ' s \qquad [ Formula 11 ]$$

$${x}_{1}^{{y}_{1}} , {x}_{2}^{{y}_{1}} , … , {x}_{{{m}^{′}}_{1}}^{{y}_{1}} \qquad [ Formula 12 ]$$

creates a pair (second pair) of S_{User}'s

$${x}_{1}^{{y}_{2}} , {x}_{2}^{{y}_{2}} , … , {x}_{{m}_{2}}^{{y}_{2}} and {S}_{Bus} ' s \qquad [ Formula 13 ]$$

$${x}_{1}^{{y}_{2}} , {x}_{2}^{{y}_{2}} , … , {x}_{{{m}^{′}}_{2}}^{{y}_{2}} \qquad [ Formula 14 ]$$

and creates a pair (M^{th} pair) of S_{User}'S

$${x}_{1}^{{y}_{M}} , {x}_{2}^{{y}_{M}} , … , {x}_{{m}_{M}}^{{y}_{M}} and {S}_{Bus} ' s \qquad [ Formula 15 ]$$

$${x}_{1}^{{y}_{M}} , {x}_{2}^{{y}_{M}} , … , {x}_{{{m}^{′}}_{M}}^{{y}_{M}} \qquad [ Formula 16 ]$$

As described above, the determination unit 14 sets a plurality of pieces of series data having a matching base station ID as a pair, and calculates each DTW. The calculation is expressed by the following formula.

$$DTW ( {S}_{User} , {S}_{Bus} ) = DTW ( {S}_{User}^{{y}_{1}} , {S}_{Bus}^{{y}_{1}} ) + … + DTW ( {S}_{User}^{{y}_{i}} , {S}_{Bus}^{{y}_{i}} ) + … + DTW ( {S}_{User}^{{y}_{M}} , {S}_{Bus}^{{y}_{M}} ) \qquad [ Formula 17 ]$$

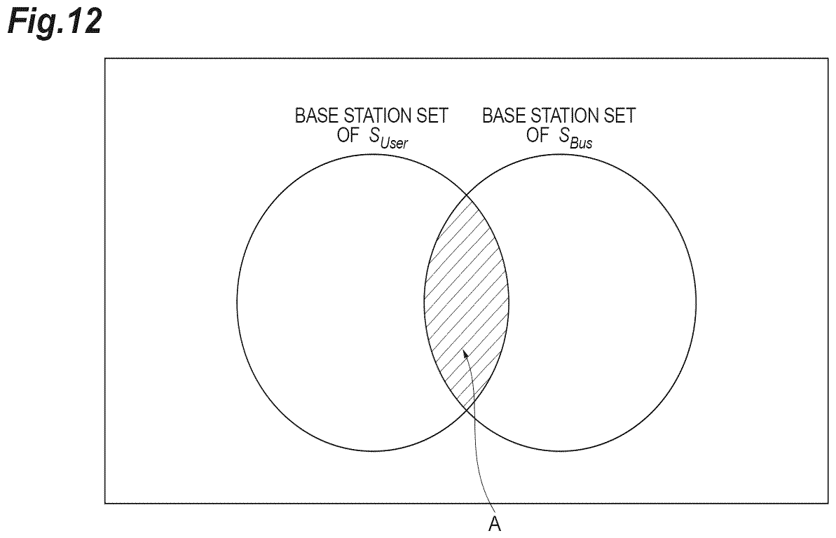

FIG. 12 is a view showing a venn diagram example of a logical product of base station sets. A plurality of pieces of series data having a matching base station ID correspond to an oblique line region A that is a logical product (common set) of a base station set of S_{User} and a base station set of S_{Bus} shown in FIG. 12.

Here, the numbers of base stations 2 in S_{User} and S_{Bus} may not match each other. A penalty is imposed on a mismatched base station 2. That is, the determination unit 14 calculates a penalty cost for a mismatched component of S_{User} and S_{Bus}. For example, in a case where the mismatched base station 2 occur, the determination unit 14 calculates a corresponding cost by the following formula.

$$\begin{matrix}cost = cost ( {S}_{User} ) + cost ( {S}_{Bus} ) \\ = {\sum }_{{y}_{i}}^{Y} {\sum }_{m}^{{M}^{{y}_{i}}} \{ cost ( {x}_{m}^{{y}_{i}} ) \} \\ = {λ}_{RSSI} \cdot \vert \frac{1}{{x}_{1}^{RSSI}} \vert + {λ}_{RSRP} \cdot \vert \frac{1}{{x}_{1}^{RSRP}} \vert + {λ}_{RSRQ} \cdot \vert \frac{1}{{x}_{1}^{RSRQ}} \vert + \\ {λ}_{SINR} \cdot \vert \frac{1}{{x}_{1}^{SINR}} \vert + {λ}_{Latency} \cdot \vert \frac{1}{{x}_{1}^{Latency}} \vert + …\end{matrix} \qquad [ Formula 18 ]$$

Here, Y represents the maximum number of the base stations 2. m represents an index of variable length data of the base station yᵢ, that is,

$${x}^{{y}_{i}} \qquad [ Formula 19 ]$$

$${M}^{{y}_{i}} \qquad [ Formula 20 ]$$

represents a maximum value of an index of variable length data of a base station yᵢ, that is,

$${x}^{{y}_{i}} \qquad [ Formula 21 ]$$

Note that with regard to RSSI, RSRP, RSRQ, and Latency, since the larger an absolute value, the worse the performance, an inverse ratio is used. In practical cost calculation, it is not always necessary to obtain the sum of all parameters, and any one piece of communication information such as RSRQ may be used as a representative.

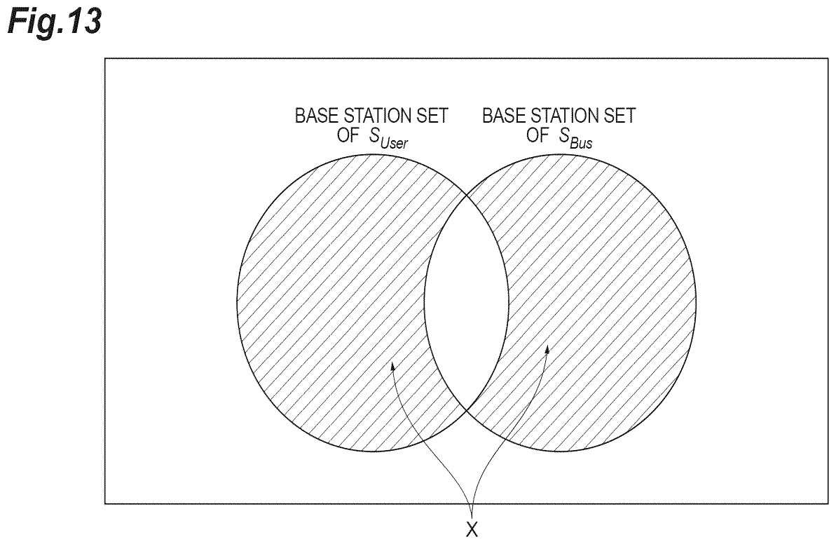

FIG. 13 is a view showing a venn diagram example of logical OR of base station sets. A plurality of pieces of series data with a mismatched base station ID correspond to the oblique line region X that is logical OR between the base station set of S_{User} and the base station set of S_{Bus} shown in FIG. 13. The determination unit 14 imposes a penalty, for example, in a case where strong radio waves other than the logical product is observed.

Similarity that is finally obtained by the determination unit 14 is determined by an expression of “DTW (S_{User}, S_{Bus})+cost”. The determination unit 14 may make a bus usage determination based on a threshold value. For example, when a value of the similarity is smaller than a predetermined threshold value, the determination unit 14 may determine that matching with bus usage is established (the user 4 is moving on the bus 5). The threshold value may also be determined by preparing ground truth data for bus usage determination and performing searching so that accuracy of the determination is maximized.

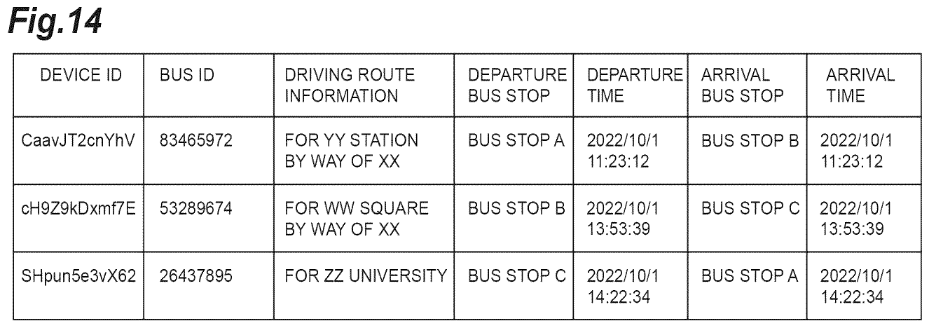

The determination unit 14 may register a determination result as a transportation means determination result table. FIG. 14 is a view showing a table example of the transportation means determination result table. In the transportation means determination result table shown in FIG. 14, a device ID that is identification information of the terminal 3 carried by the user 4, a bus ID that is identification information of the bus 5 that is determined by the determination unit 14 as a bus on which the user 4 gets and is moving, driving route information relating to a driving route of the bus 5, a departure bus stop that is a bus stop from which the bus 5 departs, a departure time that is time at which the bus departs from the departure bus stop, an arrival bust stop that is a bus stop at which the bus 5 arrives, and an arrival time that is time at which the bus arrives at the arrival bus stop are associated with each other. The determination unit 14 may generate the transportation means determination result table with reference to at least one of the base station communication information table, the device location information table, the bus stop arrival/departure information table, the correspondence information table of the device ID and the bus ID, the latitude/longitude information table of the bus stop, and the series data table of communication records of the terminal.

Hereinbefore, details of the determination made by the determination unit 14 have been described.

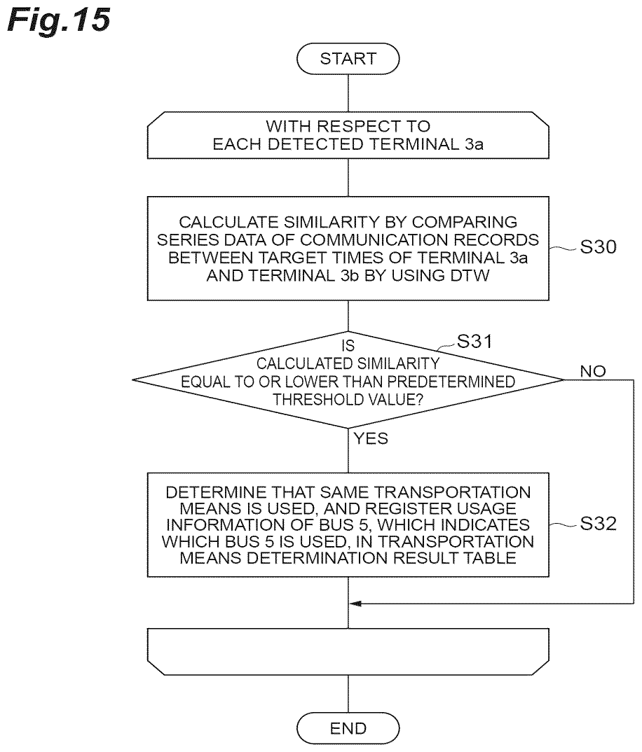

FIG. 15 is a flowchart showing an example of a determination process executed by the movement determination device 1. This determination process is performed with respect to each of a plurality of terminals 3a (the plurality of terminals 3a extracted (detected) in S21 in FIG. 11, or the like) which are targets. First, the determination unit 14 calculates the similarity by comparing series data of communication records between target times (such as “between the departure time and the arrival time” in S22 of FIG. 11) of the terminal 3a and the terminal 3b by using DTW (step S30). Next, the determination unit 14 determines whether or not the similarity calculated in S30 is equal to or less than a predetermined threshold (step S31). In a case where it is determined in S31 that the similarity is equal to or less than the predetermined threshold (S31: YES), the determination unit 14 determines that (the terminal 3a and 3b) use the same transportation means (determines that the user 4a is a user of the bus 5a), and registers usage information of the bus 5a, which indicates which bus 5a is used, in the transportation means determination result table (step S32). In a case where it is determined in S31 that the similarity is not equal to or less than the predetermined threshold (S31: NO) (in a case where it is determined that (terminal 3a and terminal 3b) do not use the same transportation means (in a case where it is determined that user 4a is not a user of bus 5a)), or the determination process is repeatedly executed for the remaining terminals 3a (when there are unprocessed terminals 3a) in subsequence to S32, and the determination process is completed for all terminals 3a, the determination process is completed.

The output unit 15 outputs a determination result that is input from the determination unit 14 or stored in the storage unit 10. The output unit 15 may transmit the determination result to another device via a communication device 1004 (described later), or may display the determination result on a display that is an output device 1006 (described later) or the like. The output unit 15 may output various tables stored in the storage unit 10, for example, the transportation means determination result table.

Next, an operational effect of the movement determination device 1 according to the embodiment will be described.

The movement determination device 1 includes the determination unit 14 that determines, based on comparison of communication information relating to communication between each of two terminals 3 performing mobile communication and the base station 2 at predetermined time, whether or not the two terminals 3 are moving together at the predetermined time. According to this configuration, the determination as to whether the two terminals 3 are moving together at the predetermined time based on comparison of the communication information of each of the two terminals 3 performing mobile communication at the predetermined time. That is, it is possible to make a determination as to whether or not the two terminals 3 performing mobile communication are moving together.

In addition, according to the movement determination device 1, one of the two terminals 3 may be carried by the user 4 and the other may be installed in the bus 5. The determination unit 14 may make a determination as to whether or not the user 4 is moving on the bus 5 at predetermined time. According to this configuration, the determination as to whether or not the user 4 is moving on the bus 5 at predetermined time can be made.

In addition, in the movement determination device 1, the communication information may be information relating the quality of communication with the base station 2. According to this configuration, it is possible to make a more accurate determination based on the quality of communication.

In addition, in the movement determination device 1, the communication information may be information relating to at least one of RSSI, RSRP, RSRQ, SINR, and transmission delay. According to this configuration, it is possible to more easily make a determination based on at least one of RSSI, RSRP, RSRQ, SINR, and transmission delay, which are easily available.

In addition, in the movement determination device 1, the determination unit 14 may calculate similarity of the communication information of each of the two terminals 3 at predetermined time, and may make a determination based on the calculated similarity. According to this configuration, it is possible to make a more accurate determination based on the similarity of the communication information.

In addition, in the movement determination device 1, the communication information may be time series data, and the determination unit 14 may calculate the similarity of a set of time series data elements relating to communication with the same base station 2 among a plurality of pieces of communication information of each of the two terminals 3 at predetermined time, and may make the determination based on the calculated similarity of each set. According to this configuration, it is possible to make a more accurate determination based on the similarity of sets of the time series data elements relating to communication with the base station 2.

in addition, in the movement determination device 1, the determination unit 14 may make a determination also based on a penalty based on time series data element leaked out from the set. According to this configuration, since the determination is made in consideration of the penalty, it is possible to make a more accurate determination.

In addition, in the movement determination device 1, the determination unit 14 may calculate the similarity by DTW. According to this, it is possible to make a more accurate determination based on the similarity by the DTW.

The movement determination device 1 is a technology for determining bus users. According to the movement determination device 1, it is possible to make a movement (transportation) similarity determination using location information and base station information. The movement determination device 1 performs DTW using mobile base station information.

As a problem, in a case of using latitude/longitude estimation information using base station position information, a location may be deviated by several hundred meters due to a location measurement error. Here, the movement determination device 1 or the movement determination system 6 avoids a nose associated with latitude/longitude conversion by directly comparing communication information before conversion into latitude and longitude. The movement determination device 1 or the movement determination system 6 directly compares communication information between the user 4 and the bus 5 by mounting the terminal 3 such as a mobile phone in the bus 5. The movement determination device 1 or the movement determination system 6 compares a base station ID, signal strength, and a transition of signal quality of radio waves by DTW in a case of mobile telephone base station. The movement determination device 1 or the movement determination system 6 extracts communication information at an interest time zone with respect to each of the terminal 3a carried by the user 4 and the terminal 3b installed in the bus 5, and compares the similarity. The movement determination device 1 or the movement determination system 6 compares radio wave strength, radio wave quality, time, and the like for every base station ID, and calculates the cumulative sum of errors. The movement determination device 1 or the movement determination system 6 adds a cost as a penalty in a case where base station IDs do not match each other.

In reality, even in the same location, a handover situation of the terminal 3 changes depending on a movement route or a time zone/day of passing, and a base station ID or timing accessed is different. However, according to the movement determination device 1 or the movement determination system 6, since the user 4a carrying the terminal 3a gets on and moves on the (same) bus 5 in which the terminal 3b is installed, almost the same base station 2 is accessed (by the terminal 3a and the terminal 3b), and this is utilized to evaluate the similarity.

The movement determination device 1 or the movement determination system 6 makes it possible to determine bus users from mobile phone base station operation information. The movement determination device 1 or the movement determination system 6 employs a method for improving the accuracy of bus usage determination by placing the terminal 3 (mobile terminal) on the bus 5 and directly comparing the mobile phone base station operation information. The movement determination device 1 or the movement determination system 6 is useful for creating various pieces of traffic statistical information such as estimation of bus congestion or estimation of a departure place and a destination place before and after using a bus.

As problems in existing technologies relating to accompanying determination (determination as to whether or not some are moving together), because the accompanying determination is made after conversion into position information, a decrease in the accuracy of the accompanying determination due to a noise associated with the conversion and a decrease in the number of dimensions of data during comparison is exemplified. According to the movement determination device 1 or the movement determination system 6, since radio information (communication information) is directly compared, the accuracy of the accompanying determination can be improved (a decrease in accuracy can be prevented).

The movement determination device 1 of the present disclosure may have the following configuration.

[1] A movement determination device including a determination unit configured to make a determination, based on comparison of communication information relating to communication between each of two terminals performing mobile communication and a base station at predetermined time, as to whether or not the two terminals are moving together at the predetermined time.

[2] The movement determination device according to [1],
wherein one of the two terminals is carried by a person, and the other is installed in a vehicle, and
the determination unit makes a determination as to whether or not the person is moving on the vehicle at the predetermined time.

[3] The movement determination device according to [1] or [2],
wherein the communication information is information relating to quality of communication with the base station.

[4] The movement determination device according to any one of [1] to [3],
wherein the communication information is information relating to at least one of received signal strength indicator (RSSI), reference signal received power (RSRP), reference signal received quality (RSRQ), signal to interference plus noise ratio (SINR), and a transmission delay.

[5] The movement determination device according to any one of [1] to [4],
wherein the determination unit calculates a similarity of the communication information of each of the two terminals at the predetermined time, and makes the determination based on the calculated similarity.

[6] The movement determination device according to any one of [1] to [5],
wherein the communication information is time series data, and
the determination unit calculates a similarity of a set of time series data elements relating to communication with the same base station among a plurality of pieces of the communication information of each of the two terminals at predetermined time, and makes the determination based on the calculated similarity of each set.

[7] The movement determination device according to [6],
wherein the determination unit makes the determination based on a penalty based on the time series data element leaked out from the set.

[8] The movement determination device according to any one of [5] to [7],
wherein the determination unit calculates the similarity by dynamic time warping (DTW).

The block diagrams used in description of the embodiment show blocks in a function unit. The functional blocks (constituent units) are realized by an arbitrary combination of at least one of hardware and software. In addition, a method for realizing respective functional blocks is not particularly limited. That is, the respective functional blocks may be realized by using one device that is physically or logically combined. In addition, two or more devices, which are physically or logically separated from each other, may be directly or indirectly connected (for example, in a wired manner, a wireless manner, or the like), and the respective functional blocks may be realized by using a plurality of the devices. The functional blocks may be realized by combining software to the one device or the plurality of devices.

Examples of functions include determining, calculating, computing, processing, deriving, examining, searching, confirming, receiving, transmitting, outputting, accessing, solving, selecting, establishing, comparing, assuming, expecting, regarding, broadcasting, notifying, communicating, forwarding, configuring, reconfiguring, allocating (mapping), assigning, and the like, but there is no limitation thereto. For example, a functional block (constituent unit) that realizes a transmission function is referred to as a transmission unit or a transmitter. A realization method of any of the functions is not particularly limited as described above.

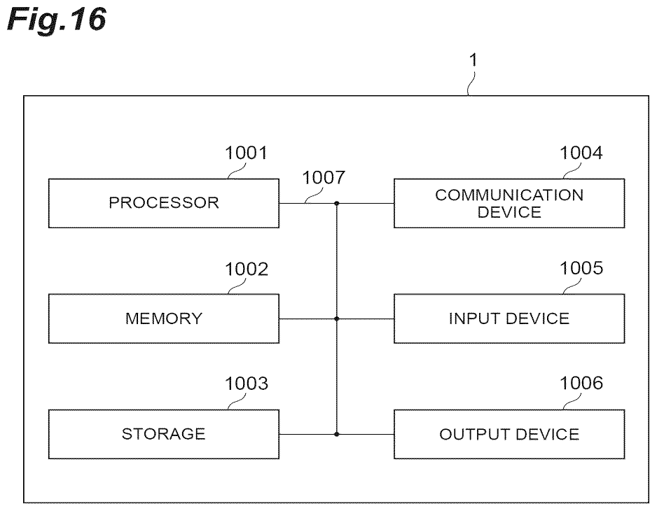

For example, the movement determination device 1 and the like in the embodiment of the present disclosure may function as a computer that performs processing of the movement determination method of the present disclosure. FIG. 16 is a view showing an example of a hardware configuration of the movement determination device 1 according to the embodiment of the present disclosure. The above-described movement determination device 1 may be configured as a computer device that physically includes a processor 1001, a memory 1002, a storage 1003, a communication device 1004, an input device 1005, an output device 1006, a bus 1007, and the like.

Note that in the following description, a term “device” may be read as a circuit, a device, a unit, or the like. The hardware configuration of the movement determination device may include the respective devices illustrated in the drawing one by one or in a plural number, or may not include a part of the devices.

Respective functions in the movement determination device 1 are realized by loading predetermined software (program) on hardware such as the processor 1001 and the memory 1002 so as to allow the processor 1001 to perform an arithmetic operation, and by controlling communication with the communication device 1004 or by controlling at least one of reading-out and writing of data in the memory 1002 and the storage 1003.

For example, the processor 1001 allows an operating system to operate so as to control the entirety of the computer. The processor 1001 may be constituted by a central processing unit (CPU) that includes an interface with a peripheral device, a control device, an arithmetic operation device, a register, and the like. For example, the registration unit 11, the conversion unit 12, the extraction unit 13, the determination unit 14, and the output unit 15, and the like may be realized by the processor 1001.

In addition, the processor 1001 reads out a program (a program code), a software module, data, or the like from at least one of the storage 1003 and the communication device 1004 into memory 1002, and performs various kinds of processing according to the program, the software module, the data, or the like. As the program, a program that causes the computer to execute at least a part of the operations described in the embodiment is used. For example, the registration unit 11, the conversion unit 12, the extraction unit 13, the determination unit 14, and the output unit 15 may be realized by a control program that is stored in the memory 1002 and operates in the processor 1001. Other functional blocks may also be realized by a similar manner. The above-described various kinds of processing have been described to be executed by one processor 1001, but may be simultaneously or sequentially executed by two or more processors 1001. The processor 1001 may be mounted by one or more chips. Furthermore, the program may be transmitted from a network through electric communication line.

The memory 1002 is a computer-readable recording medium, and may be constituted by, for example, at least one of a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can retain a program (a program code), a software module, and the like which can be executed to carry out the wireless communication method according to the embodiment of the present disclosure.

The storage 1003 is a computer-readable recording medium, and may be constituted by, for example, at least one of an optical disc such as a compact disc ROM (CD-ROM), a hard disk drive, a flexible disk, a magneto-optical disc (for example, a compact disc, a digital multi-purpose disc, and a Blue-ray (registered trademark) disc), a smart card, a flash memory (for example, a card, a stick, a key drive), a floppy (registered trademark) disk, a magnetic strip, and the like. The storage 1003 may be referred to as an auxiliary storage device. For example, the above-described storage medium may be a database including at least one of the memory 1002 and the storage 1003, a server, and other appropriate media.

The communication device 1004 is hardware (transmission and reception device) that performs communication between computers through at least one of a wired network and a wireless network, and may be referred to as, for example, a network device, a network controller, a network card, a communication module, or the like. For example, the communication device 1004 may include a high-frequency switch, a duplexer, a filter, a frequency synthesizer, and the like to realize at least one of frequency division duplex (FDD) and time division duplex (TDD). For example, the registration unit 11, the conversion unit 12, the extraction unit 13, the determination unit 14, the output unit 15, and the like may be realized by the communication device 1004.

The input device 1005 is an input device (for example, a keyboard, a mouse, a microphone, a switch, a button, a sensor, or the like) that receives an input from the outside. The output device 1006 is an output device (for example, a display, a speaker, an LED lamp, or the like) that performs output to the outside. Note that the input device 1005 and the output device 1006 may have an integral configuration (for example, a touch panel).

In addition, respective devices such as the processor 1001 and the memory 1002 are connected to each other through a bus 1007 for information communication. The bus 1007 may be configured by using a single bus, or by using buses different between devices.

In addition, the movement determination device 1 may include hardware such as a microprocessor, a digital signal processor (DSP), an application specific integrated circuit (ASIC), a programmable logic device (PLD), and a field programmable gate array (FPGA), or a part or the entirety of respective functional blocks may be realized by the hardware. For example, the processor 1001 may be mounted by using least one piece of hardware.

Information notification may be performed by other methods without limitation to the aspect and the embodiment described in the present disclosure.

The aspect and the embodiment which are described in the present disclosure may also be applied to at least any one of long term evolution (LTE), LTE-Advanced (LTE-A), SUPER 3G, IMT-Advanced, 4th generation mobile communication system (4G), 5th generation mobile communication system (5G), future radio access (FRA), new radio (NR), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), other systems which use an appropriate system, and a next generation system that is extended on the basis of the systems. In addition, application can be made in combination of a plurality of the systems (for example, in combination of at least one of LTE and LTE-A, and 5G).

With regard to the procedure, the sequence, the flowchart, and the like in the aspect and the embodiment which are described in the present disclosure, the order thereof may be changed as long as inconsistency does not occur. For example, with regard to the method that is described in the present disclosure, elements of various steps are suggested in an exemplary order, and there is no limitation to the specific order that is suggested.

In the present disclosure, a specific operation that is performed by the base station may be performed by a higher node (upper node) according to circumstances. In a network including one or a plurality of network nodes including the base station, it is apparent that various operations which are performed for communication with the terminal can be performed by at least one of the base station and another network node (for example, MME, S-GW (golden week), or the like, but there is no limitation thereto) other than the base station. In the above description, a case where another network node other than the base station is one is exemplified, but the other network node may be a combination (for example, MME and S-GW (golden week)) of a plurality of other network nodes.

Information that is input or output, and the like may be stored in a specific location (for example, a memory), or may be managed by a management table. The information that is input or output, and the like may be subjected to rewriting, updating, or additional writing. The information that is output, and the like may be deleted. The information that is input, and the like may be transmitted to other devices.

Determination may be performed by a value (0 or 1) that is expressed by one bit, may be performed in accordance with a truth value (Boolean: true or false), or may be performed through numerical value comparison (for example, comparison with a predetermined value).

The aspect and the embodiment which are described in the present disclosure may be used alone or in combination thereof, or may be switched and used in accordance with execution. In addition, notification of predetermined information (for example, notification of “a fact of X”) is not limited to the explicit notification, and may be performed in an implicit manner (for example, notification of the predetermined information is not performed).

Hereinbefore, the present disclosure has been described in detail, but it is apparent by those skilled in the art that the present disclosure is not limited to the embodiment described in the present disclosure. The present disclosure can be executed as a variation aspect and a modification aspect without departing from the gist and the scope of the present disclosure which are determined by description of the appended claims. Accordingly, description in the present disclosure is made for exemplary explanation, and does not have any limiting meaning with respect to the present disclosure.

Even when being referred to as software, firmware, middleware, microcode, hardware description language, or other names, the software should be broadly interpreted to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted or received through a transmission medium. For example, in a case where the software is transmitted from a web site, a server, or other remote sources by using at least one of a wired technology (a coaxial cable, an optical fiber cable, a twisted pair, a digital subscriber line (DSL), or the like) and a wireless technology (infrared, microwave, or the like), at least one of these wired and wireless technologies is included in the definition of the transmission medium.

The information, the signals, and the like, which are described in the present disclosure, may be expressed by using any one of other various technologies. For example, data, an instruction, a command, information, a signal, a bit, a symbol, a chip, and the like, which are stated over the entirety of the above description, may be expressed by a voltage, a current, an electromagnetic wave, a magnetic field or a magnetic particle, a photo field or a photon, or an arbitrary combination thereof.

Note that terms described in the present disclosure and terms necessary for understanding of the present disclosure may be substituted with terms having the same or similar meaning.

The terms of “system” and “network” used in the present disclosure are compatibly used.

In addition, information, parameters, and the like which are described in the present disclosure may be expressed by using absolute values, may be expressed by using relative values from predetermined values, or may be expressed by using additional corresponding information.

The names used for the above-described parameters are not restrictive in any way. In addition, mathematical formulas and the like using these parameters may be different from those explicitly disclosed in the present disclosure.

In the present disclosure, terms such as a “base station (BS)”, a “radio base station”, a “fixed station”, a “NodeB”, an “eNodeB (eNB)”, a “gNodeB (gNB)”, an “access point”, a “transmission point”, a “reception point”, a “transmission/reception point”, a “cell”, a “sector”, a “cell group”, a “carrier”, and a “component carrier” may be compatibly used. The base station may also be referred to as terms such as a macro cell, a small cell, a femto cell, and a pico cell.

The base station can accommodate one or a plurality of (for example, three) cells. In a case where the base station accommodates the plurality of cells, the entirety of a coverage area of the base station can be classified into a plurality of small areas, and each of the small areas can provide a communication service by a base station subsystem (for example, an indoor small base station (remote radio head (RRH)). A term of a “cell” or a “sector” represents a part or the entirety of a coverage area of at least one of the base station and the base station subsystem which provide the communication service in the coverage.

In the present disclosure, the terms such as a “mobile station (MS)”, a “user terminal”, a “user equipment (UE)”, and a “terminal” can be compatibly used.

The mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terminologies.

At least one of the base station and the mobile station may be referred to as a transmission device, a reception device, a communication device, or the like. Note that at least one of the base station and the mobile station may be a device mounted on a moving body, the moving body itself, or the like. The moving body may be a vehicle (for example, a car, an airplane, or the like), an unmanned moving body (for example, a drone, an automatic driving vehicle, or the like), or a robot (a manned type or an unmanned type). Note that at least one of the base station and the mobile station includes a device that does not necessarily move during a communication operation. For example, at least one of the base station and the mobile station may be an Internet of thing (IoT) device such as a sensor.

In addition, the base station in the present disclosure may be read as a user terminal. For example, the aspect and the embodiment of the present disclosure may be applied to a configuration in which the communication between the base station and the user terminal is substituted with communication between a plurality of user terminals (for example, may be referred to as a device-to-device (D2D), vehicle-to-everything (V2X), or the like). In this case, a function provided to the base station 2 may be set as a configuration of the terminal 3. In addition, words such as “uplink” and “downlink” may be read as words (for example, “side”) corresponding to communication between terminals. For example, an uplink channel, a downlink channel, and the like may be read as a side channel.

Similarly, the user terminal in the present disclosure may be read as a base station. In this case, the function provided in the terminal 3 may be set as a configuration of the base station 2.

The term “determining” that is used in the present disclosure may include various operations. For example, the term “determining” may include regarding of judging, calculating, computing, processing, deriving, investigating, looking up (search, inquiry) (for example, looking up in a table, a database, or other data structures), or ascertaining as “determined”, and the like. In addition, the “determining” may include regarding of receiving (for example, information receiving), transmitting (for example, information transmitting), input, output, or accessing (for example, accessing to data in a memory) as “determined”, and the like. In addition, “determining” may include regarding of resolving, selecting, choosing, establishing, comparing, or the like as “determined”. That is, “determining” includes regarding of any operation as “determined”. In addition, “determining” may be read as “assuming”, “expecting”, “considering”, or the like.

A term of “connected”, “coupled”, or any variation thereof represents any direct or indirect connection or coupling between two or more elements and can include presence of one or more intermediate elements between two “connected” or “coupled” elements. The coupling or connection between the elements may be physical, logical, or a combination thereof. For example, “connection” may be read as “access”. In a case of being used in the present disclosure, it can be considered that the two elements are “connected” or “coupled” to each other by using at least one of one or more wires, cables, and printed electrical connection, and by using electromagnetic energy having a wavelength in a radio frequency region, a microwave region, and an optical (both visible and invisible) region, or the like as several non-limiting and non-inclusive examples.

Description of “based on” in the present disclosure does not represent “only based on” unless otherwise stated. In other words, description of “based on” represents both “only based on” and “at least based on”.

Any reference to elements which use a term such as “first” and “second” in the present disclosure does not generally limit the amount or the sequence of the elements. These terms can be used in the present disclosure as a convenient method of distinguishing two or more elements. Accordingly, reference to the first and second elements does not mean that only two elements can be employed, or that the first element must precede the second element in some way.

The “unit” in the configuration of each of the devices may be substituted with “portion”, “circuit”, “device”, or the like.

In the present disclosure, in a case where “include”, “including”, and a modification thereof are used, these terms are intended as comprehensive terms similar to “comprising”. In addition, a term “or” that is used in the present disclosure is not intended as an exclusive OR.

In the present disclosure, for example, in a case where articles such as “a”, “an”, and “the” are added in translation, the present disclosure may include that nouns subsequent to the articles are in a plural form.

In the present disclosure, a term of “A and B are different” may represent “A and B are different from each other”. Note that the term may represent “A and B are different from C”. Terms such as “separated” and “coupled” may be interpreted in the same manner as in “different”.

### REFERENCE SIGNS LIST

1 . . . movement determination device, 2, 2a, 2b, 2c . . . base station, 3, 3a, 3b, 3c . . . terminal, 4, 4a, 4b, 4c . . . user, 5, 5a, 5b, 5c . . . bus, 6 . . . movement determination system, 10 . . . storage unit, 11 . . . registration unit, 12 . . . conversion unit, 13 . . . extraction unit, 14 . . . determination unit, 15 . . . output unit, 1001 . . . processor, 1002 . . . memory, 1003 . . . storage, 1004 . . . communication device, 1005 . . . input device, 1006 . . . output device, 1007 . . . bus.

1. A movement determination device, comprising processing circuitry configured to:
make a determination, based on comparison of communication information relating to communication between each of two terminals performing mobile communication and a base station at predetermined time, as to whether or not the two terminals are moving together at the predetermined time.

2. The movement determination device according to claim 1,
wherein one of the two terminals is carried by a person, and the other is installed in a vehicle, and
the processing circuitry is configured to make a determination as to whether or not the person is moving on the vehicle at the predetermined time.

3. The movement determination device according to claim 1,
wherein the communication information is information relating to quality of communication with the base station.

4. The movement determination device according to claim 1,
wherein the communication information is information relating to at least one of received signal strength indicator (RSSI), reference signal received power (RSRP), reference signal received quality (RSRQ), signal to interference plus noise ratio (SINR), and a transmission delay.

5. The movement determination device according to claim 1,
wherein the processing circuitry is configured to calculate a similarity of the communication information of each of the two terminals at the predetermined time, and make the determination based on the calculated similarity.

6. The movement determination device according to claim 1,
wherein the communication information is time series data, and
the processing circuitry is configured to calculate a similarity of a set of time series data elements relating to communication with the same base station among a plurality of pieces of the communication information of each of the two terminals at predetermined time, and make the determination based on the calculated similarity of each set.

7. The movement determination device according to claim 6,
wherein the processing circuitry is configured to make the determination based on a penalty based on the time series data element leaked out from the set.

8. The movement determination device according to claim 6,
wherein the processing circuitry is configured to calculate the similarity by dynamic time warping (DTW).

9. The movement determination device according to claim 7,
wherein the processing circuitry is configured to calculate the similarity by dynamic time warping (DTW).
